(19) United States
(12) Patent Application Publication
(10) Pub. No.: US 2023/0360073 A1
(43) Pub. Date: Nov. 9, 2023

(54) INFORMATION PROCESSING DEVICE

(71) Applicant: PSI Corporation, Tokyo (JP)

(72) Inventor: Eiji OKADA, Tokyo (JP)

(21) Appl. No.: 17/312,708

(22) PCT Filed: Nov. 13, 2020
(86) PCT No.: PCT/JP2020/042475

§ 371 Date: Jun. 10, 2021

(51) Int. Cl. G06Q 30/0201; G06Q 30/0202

(52) U.S. Cl. CPC G06Q 30/0206; G06Q 30/0202

(57) ABSTRACT

In a server that predicts, as a contract price, a price of a purchase target to be provided by a supplier to a buyer, a reference setting unit sets a reference price based on an actual price of the purchase target currently or previously provided by one or more suppliers to the buyer. A purchase requirements setting unit sets purchase requirements including at least a purchase volume of the purchase target in the buyer, which are necessary for estimating a price of the purchase target to be provided to the buyer. A buyer requirements setting unit sets requirements regarding the buyer, which serve as buyer requirements including at least credit strength of the buyer. A prediction unit predicts the contract price based on the reference price, the purchase requirements, and the buyer requirements.

### TECHNICAL FIELD

The present invention relates to an information processing device.

### BACKGROUND ART

For companies and other business operators (hereinafter referred to as “buyers”) who perform purchases, such as purchasing consumable items and other necessary items and paying electricity costs, it has conventionally been common practice to acquire competitive quotes from and to negotiate prices with their business partners to reduce expenditures on purchases. There is also a technology for assisting a unit price negotiation on such a purchase (see Patent Document 1).
Patent Document 1: Japanese Unexamined Patent Application, Publication No. 2017-49795

### DISCLOSURE OF THE INVENTION

### Problems to be Solved by the Invention

However, in a case where competitive quotes are acquired, it is merely possible to compare with each other contents of the quotes respectively presented by a plurality of business operators (hereinafter referred to as “suppliers”), one of which may be an opposite party on a contract, to select one supplier to be the opposite party on a contract. Furthermore, the technology described in Patent Document 1 is applicable to cases where a price is negotiated with a supplier. However, what will be extracted merely through the technology described in Patent Document 1 are items for which having negotiations about their unit prices seems to have a great advantage. To successfully carry out a price negotiation, a buyer has to know about an item or a service that a supplier provides to an extent that the buyer is able to override what the supplier claims. However, the buyer may sometimes face difficulties in having such knowledge. In particular, in fields requiring higher levels of expertise, it is extremely difficult for the buyer to have such knowledge to an extent that the buyer is able to override supplier claims. Therefore, the buyer may be often forced to accept a content of a quote that a supplier has presented, without the buyer being able to verify its appropriateness.

In view of the situations described above, an object of the present invention is to predict a reasonable price regarded as a price to be offered by a supplier to reduce an amount of money to be paid by a buyer, allowing the buyer to optimize a purchase.

### Means for Solving the Problems

To achieve the object described above, an information processing device according to an aspect of the present invention is
an information processing device that predicts, as a contract price, a price of a target that is an item or a service to be provided by a first supplier to a buyer. The information processing device includes:
reference price setting section that sets a reference price serving as a reference used to predict the contract price, based on an actual price of the target currently or previously provided by a second supplier to the buyer;
purchase requirements setting section that sets purchase requirements including at least a purchase volume of the target by the buyer, as requirements necessary for estimating a price of the target to be provided to the buyer;
buyer requirements setting section that sets, as buyer requirements, requirements regarding the buyer, the requirements including at least credit strength of the buyer; and
prediction section that inputs the reference price, the purchase requirements, and the buyer requirements into a predetermined model that outputs a contract price to predict the contract price based on an output of the predetermined model. The predetermined model is generated or updated by applying machine learning that takes into account effects on a determination of the contract price, the effects being caused by at least one pattern among,
as one or more patterns serving as factors for a cost reduction of the target to be provided by the first supplier to the buyer,
a pattern where a procurement cost price or a manufacturing cost price by the first supplier is lowering, a pattern where a competitive environment is established, and a pattern where a supply-demand relationship is relaxing and a market price is lowering.

### Effects of the Invention

According to the present invention, predicting a reasonable price regarded as a price to be offered by a supplier makes it possible to reduce an amount of money to be paid by a buyer, allowing the buyer to optimize a purchase.

### BRIEF DESCRIPTION OF THE DRAWINGS

FIG. 1 is a view illustrating an outline of a service that an information processing system including a server according to an embodiment of an information processing device of the present invention is able to achieve;

FIG. 2 is a view illustrating an example of a framework of a purchase optimization project;

FIG. 3A is a view illustrating a specific example of patterns of factors for a cost reduction;

FIG. 3B is a view illustrating a specific example of patterns of negotiation schemes for a cost reduction;

FIG. 4 is a view illustrating an example of a configuration of the information processing system including the server according to the embodiment of the information processing device of the present invention;

FIG. 5 is a block diagram illustrating an example of a hardware configuration of the server included in the information processing system illustrated in FIG. 4;

FIG. 6 is a block diagram illustrating an example of a functional configuration for executing contract price prediction processing, in the functional configuration of the information processing system including the server in FIG. 5;

FIG. 7A is a view illustrating a specific example of various types of information used in the contract price prediction processing;

FIG. 7B is a view illustrating a specific example of various types of information used in the contract price prediction processing;

FIG. 7C is a view illustrating a specific example of various types of information used in the contract price prediction processing;

FIG. 8 is a graph illustrating a specific example of “analyzing accounting data” that takes place at Step 1 in a project design phase in the purchase optimization project in FIG. 1;

FIG. 9 is a graph illustrating a specific example of “extracting targets” that takes place at Step 1 in the project design phase in the purchase optimization project in FIG. 1;

FIG. 10 is a view illustrating a specific example of “creating a management table of purchase targets” that takes place at Step 1 in the project design phase in the purchase optimization project in FIG. 1;

FIG. 11 is a view illustrating a specific example of “creating schedule plans” that takes place at Step 2 in the project design phase in the purchase optimization project in FIG. 1;

FIG. 12 is a view illustrating a specific example of “creating a list of suppliers” that takes place at Step 4 in an individual case execution phase in the purchase optimization project in FIG. 1; and

FIG. 13 is a view illustrating a specific example of “acquiring competitive quotes, and holding electronic bidding” that takes place at Step 5 in the individual case execution phase in the purchase optimization project in FIG. 1.

### PREFERRED MODE FOR CARRYING OUT THE INVENTION

An embodiment of the present invention will now be described herein with reference to the accompanying drawings.

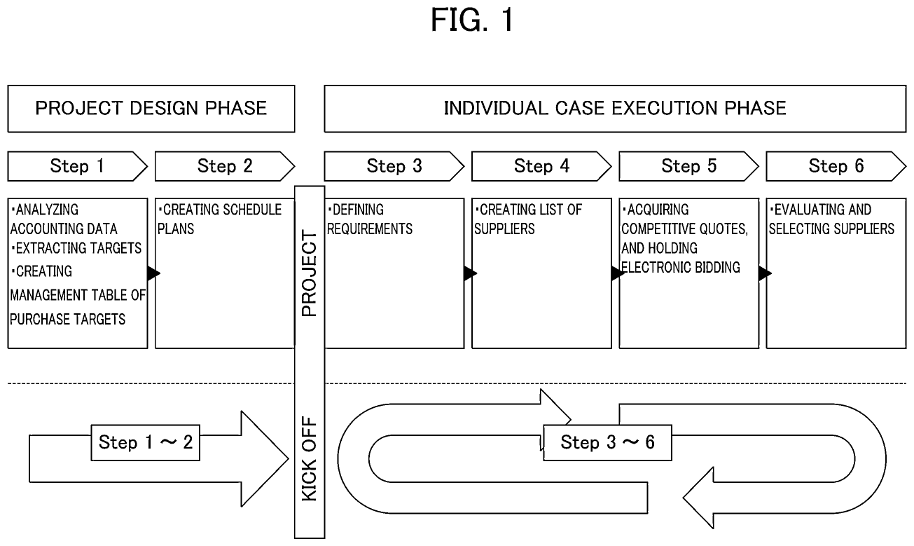

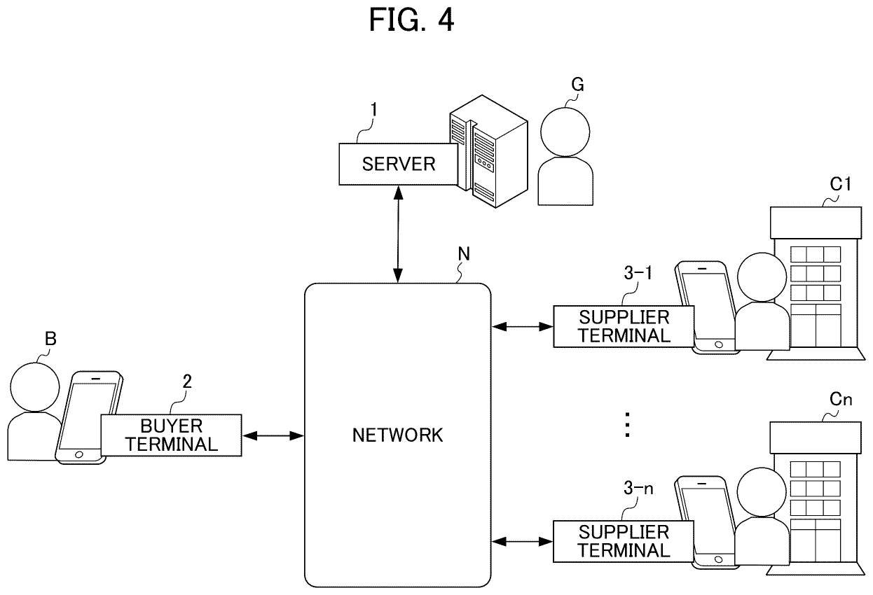

An outline of a service (hereinafter referred to as the “present service”) that is subject to the application of an information processing system (see FIG. 4, described later) to which an information processing device according to the embodiment of the present invention is applied will first be described appropriately with reference to FIGS. 1 to 3B.

The present service is an example of a service provided by a service provider to buyers and suppliers. The buyers utilizing the present service are able to each optimize a purchase of a target that is an item or a service (hereinafter referred to as a “purchase target”) that the suppliers provide. Specifically, the buyers utilizing the present service are able to each reduce a cost that varies in type within a short period of time to earn substantial benefits. Furthermore, the suppliers utilizing the present service are able to acquire opportunities of providing purchase targets to more buyers. In the present service, a reasonable price regarded as a price (hereinafter referred to as a “contract price”) of a purchase target to be provided by a supplier to a buyer is predicted. Therefore, it is possible to verify, as the service provider provides the present service to the buyers, if a price of a purchase target, which a supplier has actually offered, is reasonable. Therefore, the service provider is able to appropriately provide the present service to the buyers. As a result, the buyers are able to each reduce an amount of money to be paid to a supplier, allowing the buyers to each optimize a purchase. At the same time, the service provider is able to earn a predetermined fee as a price of providing the present service to each of the buyers.

FIG. 1 is a view illustrating the outline of the present service that the information processing system including a server according to the embodiment of the information processing device of the present invention is able to achieve.

The service provider proposes, to the buyer, a project (hereinafter referred to as a “purchase optimization project”) allowing the buyer to optimize a purchase. Upon the acceptance of the proposal, the provision of the present service begins. The purchase optimization project has a first phase and a second phase described below. The first phase is a phase of designing a purchase optimization project. The first phase described above will be hereinafter referred to as a “project design phase”. The second phase is a phase of executing an individual case. The second phase described above will be hereinafter referred to as an “individual case execution phase”.

The project design phase in the purchase optimization project will first be described. The project design phase has Step 1 and Step 2. At Step 1, analysis of accounting data, extraction of targets, and creation of a management table of purchase targets, as described below, take place.

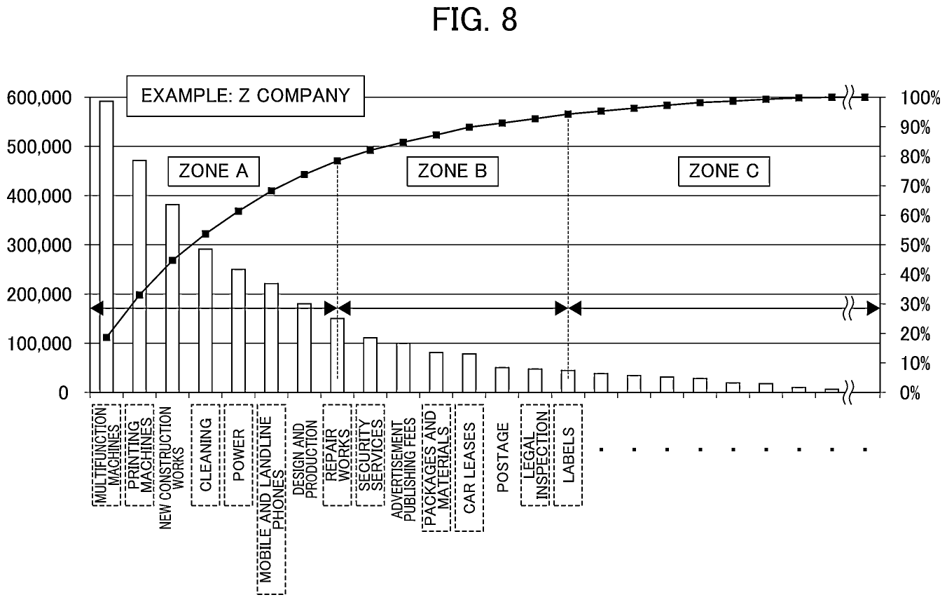

At Step 1, in analyzing accounting data, accounting data of a buyer is analyzed. Specifically, a non-disclosure agreement is concluded between the buyer and the service provider. The accounting data (for example, data regarding expenditures) is then analyzed. Note herein that an applicable specific method for analyzing accounting data of a buyer is not particularly limited. For example, a method using an ABC analysis (an importance analysis) may be used to grasp expense items having relatively greater amounts of expenditure. When the method using the ABC analysis is adopted, for example, facility investments and purchases of fixed assets are subject to separate analyses. Details of an analysis when the method using the ABC analysis is applied will be described later with reference to FIG. 8.

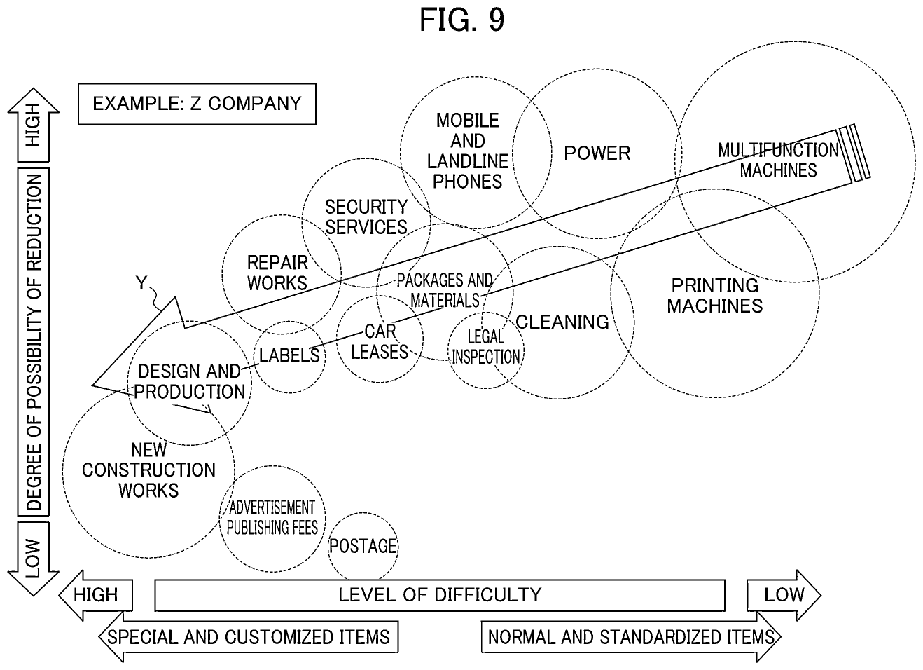

At Step 1, in extracting targets, purchase targets that are each subject to cost reduction efforts are extracted. Specifically, for example, based on a degree of possibility of a cost reduction, a level of difficulty of making cost reduction efforts, and an amount of money to be paid, an abstract idea of a priority order (hereinafter referred to as a “priority order of efforts”) along which cost reduction efforts take place is analyzed. Furthermore, a degree of priority is verified for efforts to most promptly achieve a maximum cost reduction with a minimum workload. Note that details using a specific example of extracting targets will be described later with reference to FIG. 9.

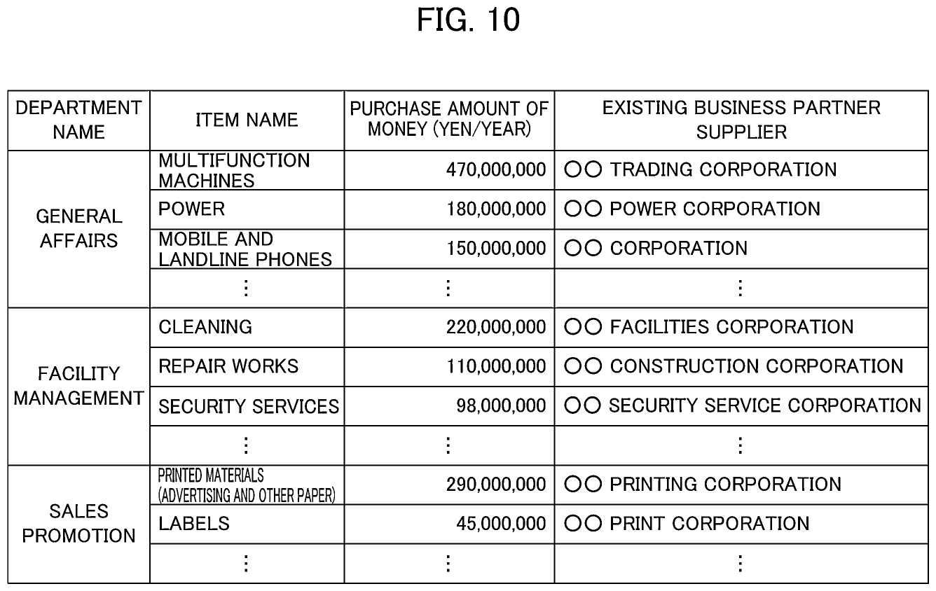

At Step 1, in creating a management table of purchase targets, a table used to manage purchase targets that are each subject to cost reduction efforts is created (hereinafter referred to as a “management table of purchase targets”). Specifically, for example, information (hereinafter referred to as “purchase situation information”) regarding situations of current purchases, such as item names, purchase amounts of money, and suppliers who are current business partners, is grasped per department in the buyer. Furthermore, individual cases of purchase targets that are deemed to be higher in the priority order of efforts to reduce a cost are extracted. Furthermore, a relationship between the buyer and the existing suppliers and their contract situations are checked. A specific method for making cost reduction efforts is then studied. A management table of purchase targets is created based on those activities including grasping, extracting, checking, and studying as described above, for example. Note that details using a specific example of creating a management table of purchase targets will be described later with reference to FIG. 10.

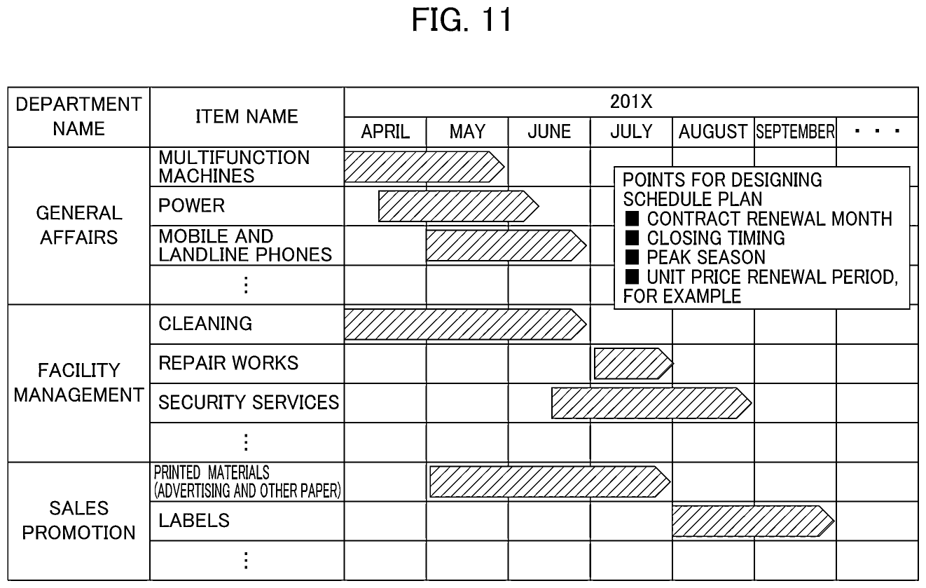

Upon the end of Step 1, as described above, Step 2 begins. At Step 2, schedule plans are created. At Step 2, in creating schedule plans, respective schedules for the individual cases that are each subject to cost reduction efforts are created. Specifically, for example, respective schedule plans for the individual cases that are each subject to cost reduction efforts are created based on the priority order of efforts for each department of the buyer. Furthermore, the purchase optimization project will be kicked off. One or more of the individual cases will be scheduled as a common project. Creating the schedule plans described above, where milestones become clear, makes it possible to prevent schedule delays. Note that details using a specific example of creating schedule plans will be described later with reference to FIG. 11.

The project design phase in the purchase optimization project has been described above. Next, the individual case execution phase will be described. When the purchase optimization project is kicked off between the service provider and the buyer, for example, the phase of the purchase optimization project transitions from the project design phase to the individual case execution phase. The individual case execution phase has Step 3 to Step 6.

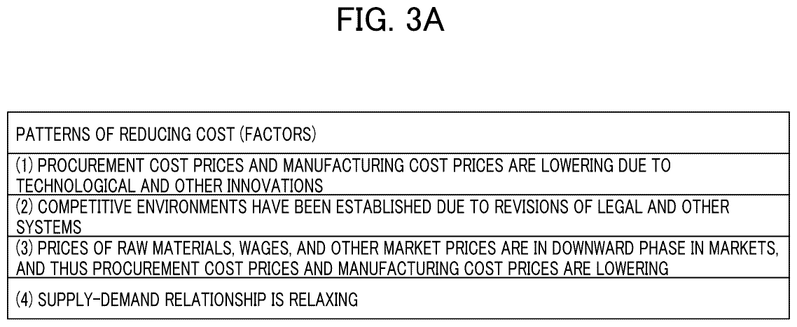

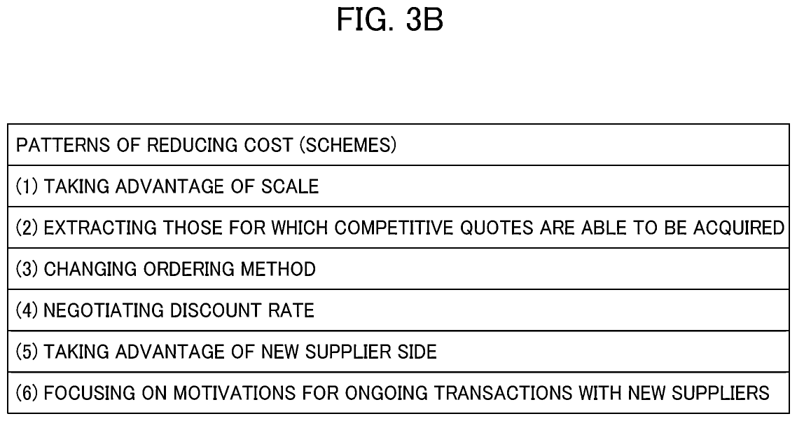

At Step 3, requirements are first defined. At Step 3, to define requirements, a specification sheet for the purchase target and a quote request sheet or a letter of invitation to tender are created. The specification sheet is created to make clear a delivery date, contract conditions, and collateral conditions including compensation, for example. Therefore, it is possible to secure the quality of the purchase target. The quote request sheet is created as a request sheet to be presented to each of a plurality of suppliers to acquire competitive quotes from the plurality of suppliers. The letter of invitation to tender is created as a letter of invitation to be presented to each of the plurality of suppliers when the buyer intends to hold electronic bidding. In the present embodiment, an amount of money acquired by multiplying a scheduled purchase volume by the buyer with a reference unit price set based on results of past purchase and future plans of the buyer, for example, is set as a reference price. The quote request sheet or the letter of invitation to tender is created based on the reference price. Note that details of a definition of the reference price and other definitions will be described later appropriately with reference to FIGS. 3A and 3B.

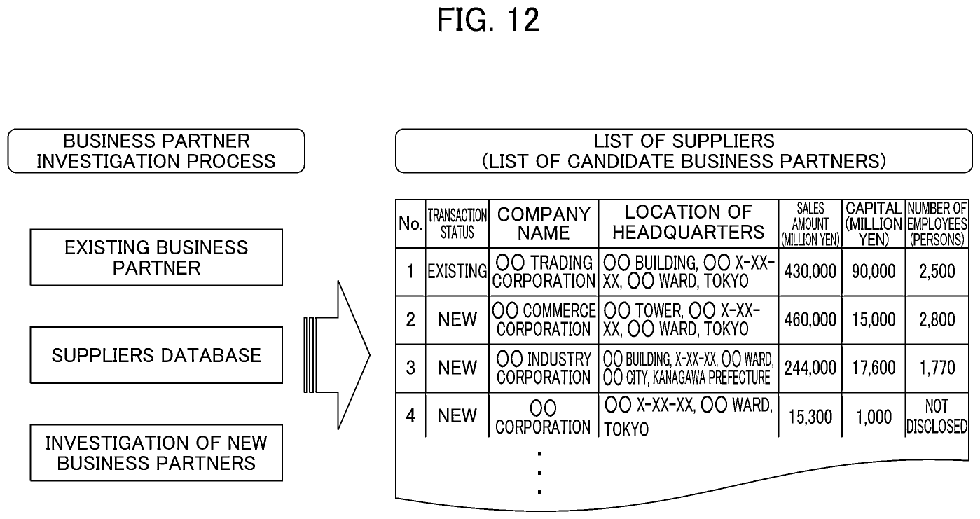

Next, at Step 4, a list of suppliers is created. At Step 4, a list including information regarding one or more suppliers who are deemed to be candidate business partners is created as a list of suppliers. Specifically, for example, a database storing various types and forms of information regarding suppliers (hereinafter referred to as “supplier information”) is utilized to create a list of suppliers. In the list of suppliers, suppliers that the buyer has approved are described. Note that details using a specific example of creating a list of suppliers will be described later with reference to FIG. 12.

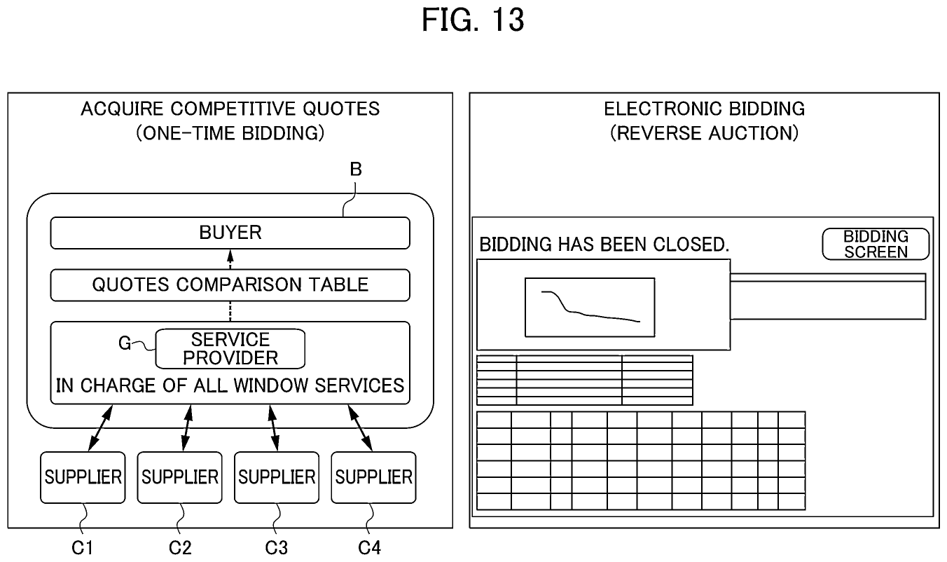

Next, at Step 5, competitive quotes are acquired, and electronic bidding is held. Note that executing the prediction of a contract price, described later, before Step 5 is advantageous for the appropriate execution of Step 5 and subsequent steps. At Step 5, as activities of acquiring competitive quotes, and holding electronic bidding, competitive quotes are acquired from the plurality of suppliers, and electronic bidding is held, in order to grant a prioritized negotiation right. Specifically, for example, the service provider requests a quote from each of the plurality of suppliers to acquire competitive quotes. The service provider then creates and presents to the buyer, as a quotes comparison table, a table summarizing a result comparing quotes respectively and eventually acquired from the plurality of suppliers. To hold electronic bidding, a Website dedicated to electronic bidding, which the present service provides, may be utilized. An existing reverse auction site may otherwise be utilized. Therefore, it is possible to enhance cost reduction effects. Note that details using a specific example of acquiring competitive quotes, and holding electronic bidding will be described later with reference to FIG. 13.

Next, at Step 6, suppliers are evaluated and selected. At Step 6, the suppliers are evaluated. One supplier is then selected as a contractor to the buyer, based on a result of the evaluation. Specifically, for example, the suppliers are evaluated from various points of view, not only in terms of price, but also various other aspects, such as the quality of the purchase target, guarantee, delivery date, company's credit, and records with other companies. To this end, an opportunity of an interview between the buyer and each of the suppliers is provided as necessary (hereinafter referred to as a “supplier interview”). A supplier who has held the first place in the evaluation of the competitive quotes or in the electronic bidding, i.e., who has won the prioritized negotiation right, is able to attend the supplier interview in principle. However, another supplier who has held the second or lower place may be able to attend the supplier interview. In this case, for example, by taking into account feedback from a result of the supplier interview with the supplier who has held the first place, a supplier interview with the supplier who has held the second place may take place.

During the supplier interview, the content of the quote that the supplier has presented (for example, the quality of the purchase target, the guarantee, and the delivery date) is confirmed. Furthermore, during a supplier interview with a new supplier, the content (for example, the quality of the purchase target, the guarantee, the delivery date, the company's credit, and the records with other companies) according to a result of the evaluation of the supplier is confirmed.

Furthermore, in addition to the supplier interviews, as necessary for creating a quote and for evaluating suppliers, for example, proposal letters that the suppliers have created are collected, plans are presented, sample evaluation meetings are held, and visit tours are held. The supplier selected through “evaluating and selecting suppliers” concludes a purchase contract with the buyer. Note that, in the present service, in order to achieve a cost reduction within a short period of time, processes for concluding a purchase contract between the buyer and a supplier are supported.

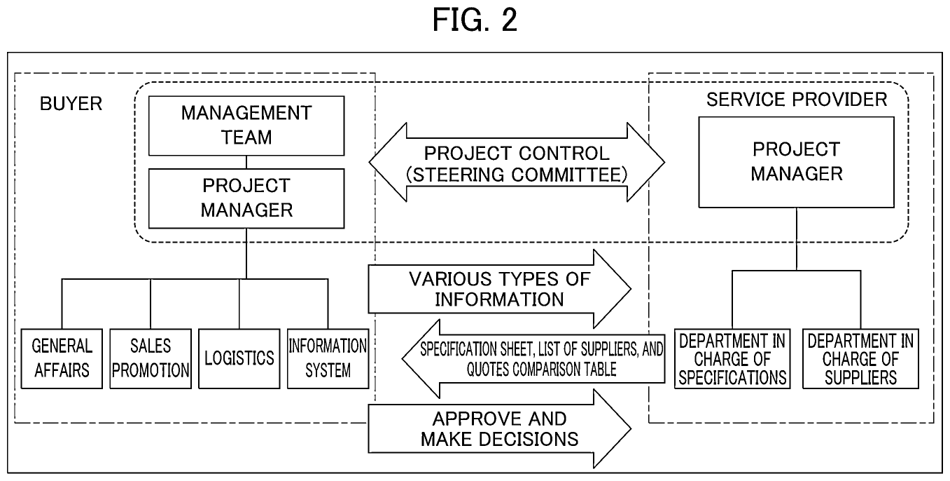

To summarize those described above, for example, the framework as illustrated in FIG. 2 makes it possible to achieve a purchase optimization project.

FIG. 2 is a view illustrating an example of a framework of a purchase optimization project.

The purchase optimization project is controlled by a steering committee (an acting committee) consisting of a representative on the buyer side and a representative on the service provider side. In the steering committee (the acting committee), decisions will be made, and regular reports will be given, regarding the objective of the whole project with the management perspective, for example. Note that the representative on the buyer side corresponds to a management team or a project manager, for example, and the representative on the service provider side corresponds to a project manager, for example.

In the purchase optimization project, various types of information are provided from the buyer side to the service provider side in order to execute the project design phase in FIG. 1. Specifically, for example, various types of information are provided from departments in charge on the buyer side (for example, a department in charge of general affairs, a department in charge of sales promotion, a department in charge of logistics, and a department in charge of information system) to departments in charge on the service provider side (for example, a department in charge of specifications and a department in charge of suppliers). The information to be provided from the buyer side to the service provider side includes information regarding current purchase data, accounting data, contract situations, and existing suppliers, for example.

Furthermore, in the purchase optimization project, a specification sheet, a list of suppliers, and a quotes comparison table, for example, are presented by each of the departments in charge on the service provider side to each of the departments in charge on the buyer side in order to execute the individual case execution phase in FIG. 1. Therefore, it is possible to achieve efficient outputs and to maximize a cost reduction. Furthermore, in the purchase optimization project, approvals will be given and decisions will be made per individual case from the departments in charge on the buyer side to the departments in charge on the service provider side in order to execute the individual case execution phase in FIG. 1. Therefore, it is possible for the buyer side and the service provider side to communicate with each other during the whole purchase optimization project.

The flow and the framework of the whole purchase optimization project that the present service is able to achieve have been described above. Next, a specific method of allowing the buyer to maximize a cost reduction will be described with reference to FIGS. 3A and 3B. Specifically, a method of predicting a “contract price”, described above, at a desired timing (for example, a timing before Step 5 described above), and of verifying if an estimated price and a bid price that the supplier has offered are reasonable will be described.

In the present service, to predict a contract price, a reference price, purchase requirements, and buyer requirements are taken into account. The reference price is a price serving as a reference used to predict a contract price. The reference price is also a price further used to create a quote request sheet and a letter of invitation to tender described above. The reference price is calculated, for example, as described above, by multiplying a scheduled purchase volume by the buyer with a reference unit price set based on results of past purchase and future plans of the buyer, for example. Specifically, for example, respective prices of purchase targets currently or previously provided by one or more suppliers to the buyer are taken into account. Note that “results of past purchase” may include purchase results from the supplier who is the opposite party on the current contract. The “purchase requirements” refer to requirements regarding purchases on the buyer side, which are necessary for estimating a price of a purchase target to be provided by a supplier to the buyer. It is possible to include, in the purchase requirements, a purchase volume of the purchase target (for example, a manufacturing lot and a size). The “buyer requirements” refer to requirements regarding credentials on the buyer side. It is possible to include, in the buyer requirements, credit strength of the buyer (for example, scale and financial resources of the company).

Specifically, for example, in a case where a purchase target to be provided by a supplier to the buyer is “power”, it is possible to predict a contract price in accordance with a procedure described below. That is, for example, the reference price is set based on electricity costs of power currently or previously provided by one or more suppliers (for example, electric power companies) to the buyer. Furthermore, for example, purchase requirements including power usage and amperage capacity are set. Furthermore, for example, buyer requirements including a capital amount, the number of employees, and a sales amount, for example, which indicate the credit strength of the buyer, are set. A contract price is then predicted based on the reference price, the purchase requirements, and the buyer requirements set as described above.

The present service makes it possible to allow, when a target that is an item or a service is to be provided by a supplier to the buyer, the buyer to purchase the target at a lower price (i.e., to reduce a cost) without sacrificing the quality. The factors and negotiation schemes will now be described with reference to FIGS. 3A and 3B. FIGS. 3A and 3B are views respectively illustrating specific examples of patterns of factors for a cost reduction and negotiation schemes for a cost reduction.

That is, in the present service, in addition to the reference price, the purchase requirements, and the buyer requirements, effects of one or more patterns (hereinafter referred to as “factor patterns”) serving as factors for a cost reduction are taken into account, making it possible to predict a more appropriate contract price. Furthermore, in the present service, in addition to the reference price, the purchase requirements, and the buyer requirements, effects of one or more patterns (hereinafter referred to as “negotiation scheme patterns”) serving as negotiation schemes for a cost reduction of a target that is an item or a service to be provided by a supplier to the buyer are taken into account, making it possible to predict a further more appropriate contract price.

FIG. 3A illustrates four patterns as a specific example of factor patterns. That is, in the present service, the four patterns serving as factor patterns are: (1) procurement cost prices and manufacturing cost prices are lowering due to technological and other innovations; (2) competitive environments have been established due to revisions of legal and other systems; (3) prices of raw materials, wages, and other market prices are in a downward phase in markets, and thus procurement cost prices and manufacturing cost prices are lowering; and (4) supply-demand relationship is relaxing. If at least one of the four patterns is met, it is conceivable in many cases that the buyer has purchased a purchase target at a price relatively higher than a market price due to their assumptions. Therefore, taking into account effects of at least one of the four patterns makes it possible to predict a contract price allowing the buyer to achieve a purchase at a price close to a market price, that is, to achieve a further cost reduction. In other words, taking into account the effects of at least one of the four patterns makes it possible to take into account and grasp economic trends and cases with other companies. That is, taking into account the economic trends and the cases with other companies makes it possible to predict a contract price allowing the buyer to achieve a purchase at a lower price. Note that it is possible to utilize the four patterns to extract targets as purchase targets. Note that a specific example of this extraction will be described later with reference to FIG. 9.

FIG. 3B illustrates six patterns as a specific example of negotiation scheme patterns. That is, in the present service, the six patterns serving as the negotiation scheme patterns are: (1) taking advantage of scale; (2) extracting those for which competitive quotes are able to be acquired; (3) changing ordering method; (4) negotiating discount rate; (5) taking advantage of new supplier side; and (6) focusing on motivations for ongoing transactions with new suppliers. Note that, since appropriate negotiation scheme patterns may differ per individual case, a plurality of ones of the negotiation scheme patterns may have to be combined. Therefore, in the present service, appropriate one or more of the negotiation scheme patterns are adopted in accordance with a situation the buyer is facing. Taking into account effects of patterns adopted as described above makes it possible to predict a contract price allowing the buyer to achieve a purchase at a lower price.

Next, a configuration of the information processing system achieving the provision of the present service described above, that is, the information processing system including the server according to the embodiment of the information processing device of the present invention will be described with reference to FIG. 4. FIG. 4 is a view illustrating an example of the configuration of the information processing system including the server according to the embodiment of the information processing device of the present invention.

The information processing system illustrated in FIG. 4 includes a server 1, a buyer terminal 2, and supplier terminals 3-1 to 3-n (n is an integer value of 1 or greater). The server 1, the buyer terminal 2, and the supplier terminals 3-1 to 3-n are coupled to each other via a predetermined network N such as the Internet.

The server 1 is an information processing device that a service provider G manages. The server 1 appropriately communicates with the buyer terminal 2 and the supplier terminals 3-1 to 3-n, respectively, to execute various types of processing achieving the present service.

The buyer terminal 2 is an information processing device that a buyer B operates. The buyer terminal 2 is a personal computer, a smart phone, or a tablet, for example. Note that, for purposes of description, only one person (one company) being illustrated represents the buyer B. However, it is possible to provide the present service to a plurality of buyers in parallel. In that case, the plurality of buyers are each provided with the one or more buyer terminals 2.

The supplier terminals 3-1 to 3-n are, respectively, information processing devices that suppliers C1 to Cn operate. The supplier terminals 3-1 to 3-n are, respectively, personal computers, smart phones, or tablets, for example. Note that, for purposes of description, the suppliers C1 to Cn being illustrated are respectively provided with the supplier terminals 3-1 to 3-n only. However, and obviously, the suppliers C1 to Cn being illustrated may be each provided with a plurality of supplier terminals. Note that, unless otherwise specifically distinguished from each other, the supplier terminals 3-1 to 3-n will be hereinafter collectively referred to as “supplier terminals 3”.

The buyer B and the suppliers C are respectively able to use, in the present embodiment, for example, the buyer terminal 2 and the supplier terminals 3 each installed with a special application (hereinafter referred to as a “special App”) provided for users of the present service to utilize the present service. Furthermore, for example, the buyer B and the suppliers C are respectively able to utilize the present service via a Website that the service provider G is managing, when the Website is displayed through a browser function of each of the buyer terminal 2 and the supplier terminals 3. Note that, unless otherwise specifically noted, the expression “the buyer B operates the buyer terminal 2” will hereinafter mean one of those described below. That is, it means that the buyer B launches the special App installed in the buyer terminal 2 to perform various types of operations or utilizes the present service via the Website displayed through the browser function of the buyer terminal 2. Furthermore, the expression “the suppliers C respectively operate the supplier terminals 3” will hereinafter mean one of those described below. That is, it means that the suppliers C each launch the special App installed in the supplier terminals 3 to perform various types of operations or each utilize the present service via the Website displayed through the browser function of each of the supplier terminals 3.

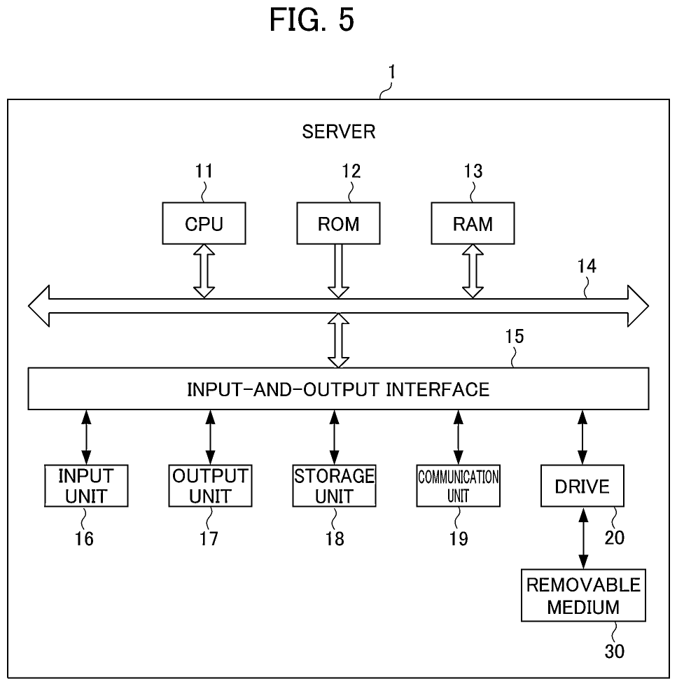

FIG. 5 is a block diagram illustrating an example of a hardware configuration of the server included in the information processing system illustrated in FIG. 4.

The server 1 includes a central processing unit (CPU) 11, a read only memory (ROM) 12, a random access memory (RAM) 13, a bus 14, an input-and-output interface 15, an input unit 16, an output unit 17, a storage unit 18, a communication unit 19, and a drive 20.

The CPU 11 runs programs recorded in the ROM 12 or programs loaded from the storage unit 18 to the RAM 13, and, in accordance with the programs, executes various types of processing. The RAM 13 appropriately stores, for example, data necessary for the CPU 11 to execute various types of processing.

The CPU 11, the ROM 12 and the RAM 13 are coupled to each other via the bus 14. The bus 14 is further coupled to the input-and-output interface 15. The input-and-output interface 15 is coupled to the input unit 16, the output unit 17, the storage unit 18, the communication unit 19, and the drive 20.

The input unit 16 is formed of a keyboard, for example, to accept various types of information. The output unit 17 is formed of a display, such as a liquid crystal display, and a loud-speaker, for example, to output various types of information in the forms of image and audio. The storage unit 18 is formed of a dynamic random access memory (DRAM), for example, to store various types of data. The communication unit 19 communicates with other devices (for example, the buyer terminal 2 and the supplier terminals 3 in FIG. 5) via the network N including the Internet.

The drive 20 is appropriately attached with a removable medium 30 such as a magnetic disk, an optical disk, a magnetic optical disk, or a semiconductor memory. A program read from the removable medium 30 by the drive 20 is installed into the storage unit 18 as required. Furthermore, similar to the storage unit 18, the removable medium 30 is able to store various types of data stored in the storage unit 18.

Note that, although not illustrated, the buyer terminal 2 and the supplier terminals 3 in FIG. 4 each also have a configuration basically similar to the hardware configuration illustrated in FIG. 5. Therefore, the descriptions of hardware configurations of the buyer terminal 2 and the supplier terminals 3 are omitted.

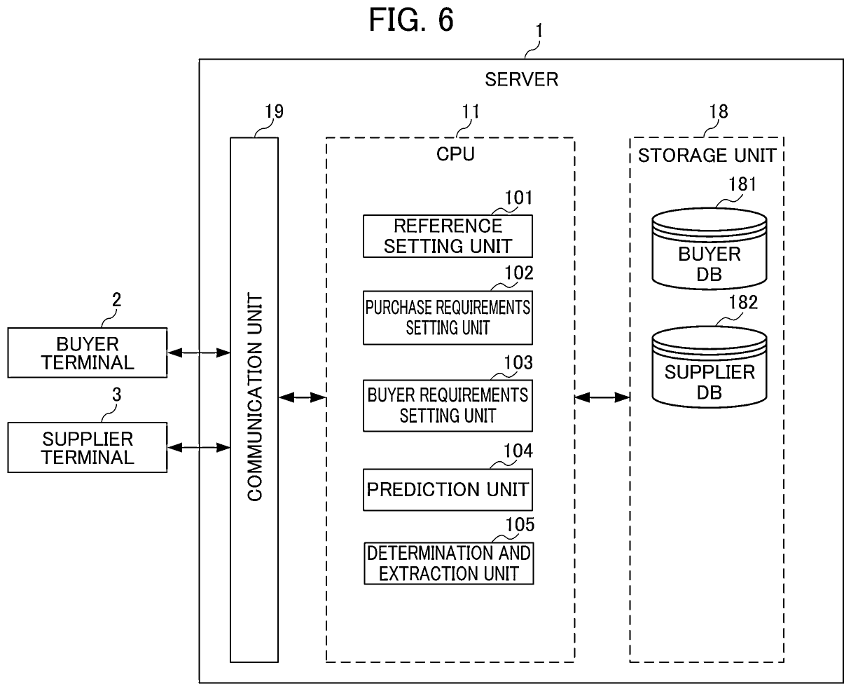

It is possible to execute various types of processing including the contract price prediction processing in the server 1 through cooperation of various types of hardware and various types of software in the server 1 in FIG. 5, as described above. As a result, the service provider G is able to provide the present service described above to the buyer B and the suppliers C. Note herein that the contract price prediction processing refers to processing to be executed to provide the present service described above, and refers to a series of processing that continue until a contract price is predicted. A functional configuration for executing the contract price prediction processing to be executed in the server 1 according to the present embodiment will now be described with reference to FIG. 6.

FIG. 6 is a block diagram illustrating an example of the functional configuration for executing the contract price prediction processing, in the functional configuration of the information processing system including the server in FIG. 5.

As illustrated in FIG. 6, when the contract price prediction processing is controlled for its execution in the CPU 11 of the server 1, a reference setting unit 101, a purchase requirements setting unit 102, a buyer requirements setting unit 103, a prediction unit 104, and a determination and extraction unit 105 are caused to function. Furthermore, in a region of the storage unit 18 of the server 1, a buyer database (DB) 181 and a supplier DB 182 are provided. In the buyer DB 181, various types and forms of information regarding the buyer B (hereinafter referred to as “buyer information”) is managed in association with an ID, for example, that allows the buyer B to be uniquely identified. In the supplier DB 182, the supplier information described above is managed in association with IDs, for example, that allow the suppliers C to be each uniquely identified.

The reference setting unit 101 sets a reference price that is a price serving as a reference used to predict a contract price, based on purchase results from one or more suppliers C who have currently or previously provided purchase targets to the buyer B. Specifically, for example, the reference setting unit 101 sets the reference price based on the buyer information stored in the buyer DB 181 and the supplier information stored in the supplier DB 182 (in particular, purchase results and procurements that the buyer B has performed). Note that the one or more suppliers C who have currently or previously provided purchase targets to the buyer B may include the suppliers C subject to contract price prediction. That is, as long as it is possible to reduce a cost, for example, the buyer B may successively conclude a contract with the supplier C with which the buyer B has currently concluded a contract or the supplier C with which the buyer B had previously concluded a contract.

The purchase requirements setting unit 102 sets purchase requirements including at least a purchase volume of the purchase target by the buyer B, as requirements necessary for estimating a price of the purchase target to be provided to the buyer B. Specifically, for example, the purchase requirements setting unit 102 sets the purchase requirements based on a manufacturing lot and a size, for example, of the purchase target, which are acquired from the buyer information stored in the buyer DB 181.

The buyer requirements setting unit 103 sets, as buyer requirements, requirements regarding the buyer B, which serve as requirements including at least the credit strength of the buyer B. As described above, the credit strength of the buyer B includes, when the buyer is a company, its scale and financial resources of the company, for example.

The prediction unit 104 predicts a contract price that the supplier C who is deemed to be a target supplier may offer, based on the reference price set by the reference setting unit 101, the purchase requirements set by the purchase requirements setting unit 102, and the buyer requirements set by the buyer requirements setting unit 103.

The method with which the prediction unit 104 predicts a contract price is not particularly limited. However, for example, one of methods described below may be adopted. That is, it is possible to adopt such a method in which a contract price is predicted based on the model which is generated or updated when the reference price, the purchase requirements, and the buyer requirements are inputted, a contract price is outputted by using a machine learning conforming to a desired method. The machine learning may conform to a desired method, as described above, and may be either supervised learning or unsupervised learning. For example, when supervised learning is applied, information on reference prices, purchase requirements, and buyer requirements, which are actually used, may be used as learning data. At the same time, information on estimated prices that are actually offered, for example, may be used as teaching data. A plurality of data sets may be prepared based on the teaching data. A non-illustrated learning device may thus be caused to apply machine learning to generate or update the model described above.

At the same time, the prediction unit 104 is able to further take into account, in addition to the reference price, the purchase requirements, and the buyer requirements, effects of one or more patterns serving as factors for a cost reduction of the purchase target to be provided by the supplier C to the buyer B to predict a contract price. Specifically, for example, the prediction unit 104 is able to take into account effects of the “factor patterns” in FIG. 3A to predict a contract price. For example, when machine learning is applied, as described above, the machine learning taking into account the effects of the “factor patterns” in FIG. 3A takes place to generate or update a model.

Furthermore, the prediction unit 104 is able to take into account, in addition to the reference price, the purchase requirements, and the buyer requirements, effects of one or more patterns serving as negotiation schemes for a cost reduction of the purchase target to be provided by the supplier C to the buyer B to predict a contract price. Specifically, for example, the prediction unit 104 is able to take into account effects of the “negotiation scheme patterns” in FIG. 3B to predict a contract price. For example, when machine learning is applied, as described above, the machine learning taking into account the effects of the “negotiation scheme patterns” in FIG. 3B takes place to generate or update a model.

Obviously, to predict a contract price, a combination of the “factor patterns” in FIG. 3A and the “negotiation scheme patterns” in FIG. 3B may be taken into account. For example, when machine learning is applied, as described above, the machine learning taking into account the effects of the combination of the “factor patterns” in FIG. 3A and the “negotiation scheme patterns” in FIG. 3B takes place to generate or update a model.

The determination and extraction unit 105 determines and extracts, from among a plurality of items or services currently provided to the buyer B, purchase targets for which contract prices are to be predicted, based on at least one determinant factor among a degree of possibility of reduction, a level of difficulty of efforts, and an amount of money to be paid. Note that a specific example of causing the determination and extraction unit 105 to extract purchase targets will be described later with reference to FIG. 9. As described above, in the present embodiment, the determination and extraction unit 105 is provided. Therefore, it is possible to focus on a purchase target for which effects of a cost reduction can be expected, and to predict a contract price that the supplier C may offer.

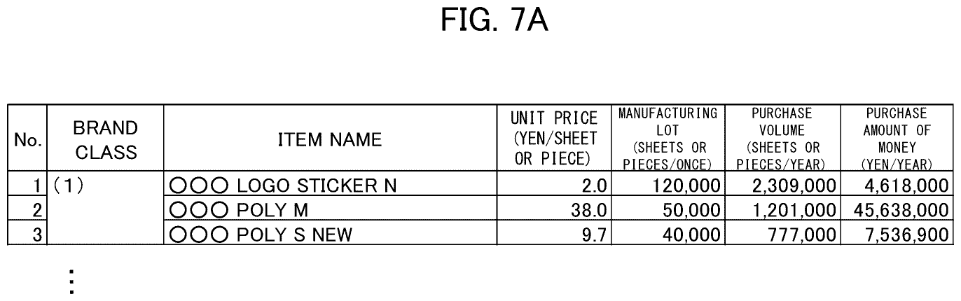

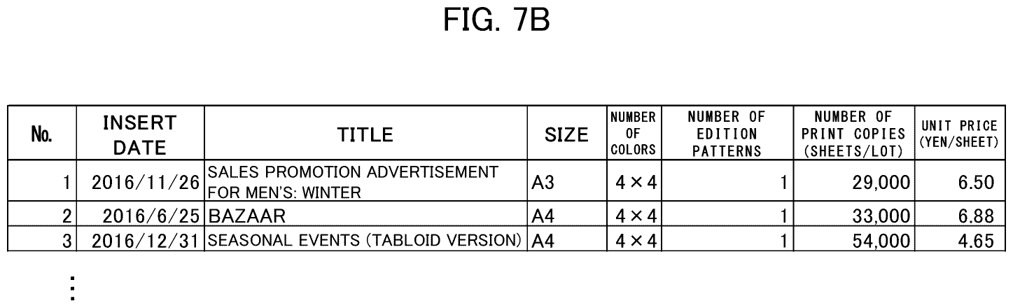

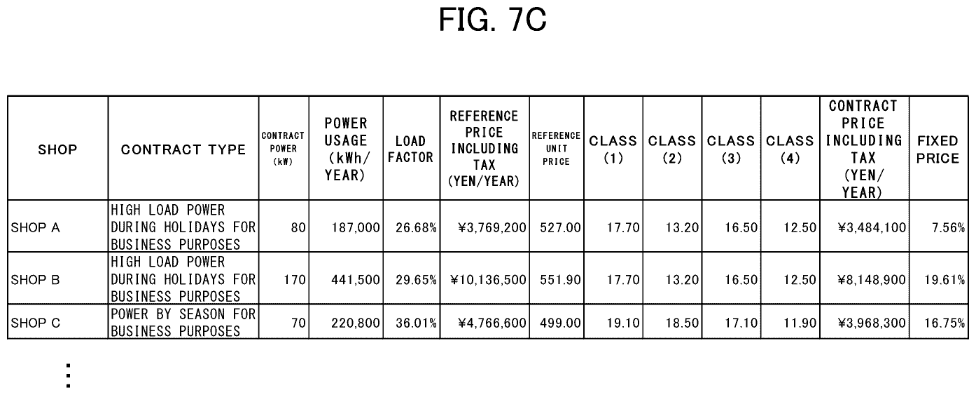

Next, specific examples of the contract price prediction processing described above will be described with reference to FIGS. 7A to 7C. FIGS. 7A to 7C are views illustrating specific examples of various types of information used in the contract price prediction processing.

FIGS. 7A and 7B illustrate specific examples of purchase results, which is used in the contract price prediction processing. The purchase results are stored and managed in the buyer DB 181 per brand or item, when purchase targets are so-called articles for daily use, as illustrated in FIG. 7A, for example. Furthermore, as illustrated in FIG. 7B, when purchase targets are printed materials such as advertising paper, the purchase results are stored and managed in the buyer DB 181 per newspaper-insert date or title.

Specifically, for example, FIG. 7A illustrates those described below, as an example of purchase results when purchase targets are articles for daily use. That is, one of the illustrated purchase targets has: a brand class of “(1)”; an item name of “OOO Logo Sticker”; a unit price (yen/sheet or piece) of “2.0”; a manufacturing lot (sheets or pieces/once) of “120,000”; a number of purchase targets (sheets or pieces/year) of “2,308,990”; and a purchase amount of money (yen/year) of “4,617,980”. One of the illustrated purchase targets has: a brand class of “(1)”; an item name of “000 Poly M”; a unit price (yen/sheet or piece) of “38.0”; a manufacturing lot (sheets or pieces/once) of “50,000”, a number of purchase targets (sheets or pieces/year) of “1,200,687”, and a purchase amount of money (yen/year) of “45,626,106”. One of the illustrated purchase targets has: a brand class of “(1)”; an item name of “Poly S New”, a unit price (yen/sheet or piece) of “9.7”; a manufacturing lot (sheets or pieces/once) of “40,000”, a number of purchase targets (sheets or pieces/year) of “776,748”, and a purchase amount of money (yen/year) of “7,534,456”.

Furthermore, for example, FIG. 7B illustrates those described below, as an example of purchase results when purchase targets are printed materials (advertising paper). That is, one of the illustrated purchase targets has: an insert date of “2016/6/25”; a title of “The men's bazaar (coats)”; a size of “B4”; a number of colors of “4×4”; a number of edition patterns of “1”; a number of print copies (sheets/lot) of “29,200”; and a unit price (yen/sheet) of “6.50”. One of the illustrated purchase targets has: an insert date of “2016/11/26”; a title of “First bazaar (Obu shop)”; a size of “B4”; a number of colors of “4×4”; a number of edition patterns of “1”; a number of print copies (sheets/lot) of “33,400”; and a unit price (yen/sheet) of “6.88”. One of the illustrated purchase targets has: an insert date of “2016/12/31”; a title of “First sale (tabloid version)”; a size of “B4”; a number of colors of “4×4”; a number of edition patterns of “1”; a number of print copies (sheets/lot) of “54,200”; and a unit price (yen/sheet) of “4.65”.

FIG. 7C illustrates a specific example of contract prices predicted as a result of the contract price prediction processing. As illustrated in FIG. 7C, it is possible to predict a contract price per shop that the buyer B owns. Specifically, for example, as to the shop name “Takinogawa shop”, a reference price for an annual electricity cost is “3,769,163 yen”, while a predicted contract price is “3,484,062 yen”. That is, it is known, through the contract price prediction processing, that there is a negotiable discount margin of a discount rate of at least “7.56%”. Furthermore, as to the shop name “Hokima shop”, a reference price for an annual electricity cost is “10,136,460 yen”, while a predicted contract price is “8,148,864 yen”. That is, it is known, through the contract price prediction processing, that there is a negotiable discount margin of a discount rate of at least “19.61%”. Furthermore, as to the shop name “Shimouma shop”, a reference price for an annual electricity cost is “4,766,559 yen”, while a predicted contract price is “3,968,250 yen”. That is, it is known, through the contract price prediction processing, that there is a negotiable discount margin of a discount rate of at least “16.75%”.

Next, a specific example of processing to be executed in the project design phase and the individual case execution phase in the purchase optimization project in FIG. 1 will be described with reference to FIGS. 8 to 13. Note that, although the functional block diagram in FIG. 6 does not illustrate functional blocks that execute the processing described above, excluding the processing executed by the determination and extraction unit 105 in FIG. 6 by using a graph in FIG. 9, the server 1 also appropriately executes the processing described above.

FIG. 8 is a graph illustrating a specific example of “analyzing accounting data” that takes place at Step 1 in the project design phase in the purchase optimization project in FIG. 1. The graph illustrated in FIG. 8 is a graph generated to perform the ABC analysis (the importance analysis), based on the accounting data of the buyer B (a Z company). As illustrated in FIG. 8, in the ABC analysis, purchase targets are arranged, from a left side to a right side of a horizontal axis, in a descending order of amount of expenditure (illustrated next to a vertical axis on the left side in the graph) (i.e., in a descending order of importance). The purchase targets are then classified, in accordance with a percentage of accumulated expenditure (illustrated next to a vertical axis on the right side in the graph), into a zone A (higher importance), a zone B (medium importance), and a zone C (lower importance). Specifically, among the purchase targets, multifunction machines, printed materials, new construction works, cleaning, power, mobile and landline phones, design and production, and repair works are classified into zone A (higher importance). Furthermore, among the purchase targets illustrated on the horizontal axis in the graph, security services, advertisement publishing fees, packages and materials, car leases, postage, legal inspection, and labels are classified into zone B (medium importance). Furthermore, although not illustrated, among the purchase targets illustrated on the horizontal axis in the graph, the purchase targets arranged toward the right side from labels are classified into zone C (lower importance). Therefore, it is known that, as illustrated in the graph in FIG. 8, the purchase targets occupying a range up to a percentage of accumulated expenditure of approximately 80% are classified into zone A. The purchase targets occupying a range between percentages of accumulated expenditure from approximately 80% to 90% are classified into zone B. The purchase targets occupying a range between percentages of accumulated expenditure from approximately 90% to 100% are classified into zone C. That is, it is conceivable that the purchase targets classified into zone A are regarded as purchase targets occupying a higher percentage range with respect to a whole expenditure, and thus should be regarded with particular emphasis as targets that are subject to a cost reduction. Note that differences between the purchase targets each surrounded by a dotted line and the purchase targets each surrounded by no dotted line, among the purchase targets illustrated on the horizontal axis in the graph, will be described later with reference to FIG. 9.

FIG. 9 is a graph illustrating a specific example of “extracting targets” that takes place at Step 1 in the project design phase in the purchase optimization project in FIG. 1.

As described above, to extract targets, an abstract idea of a priority order of efforts is analyzed based on a degree of possibility of a cost reduction, a level of difficulty of making cost reduction efforts, and an amount of money to be paid. Furthermore, a degree of priority is verified for efforts to most promptly achieve a maximum cost reduction with a minimum workload. The graph illustrated in FIG. 9 is a graph illustrating a relationship between the degree of possibility of a cost reduction (a vertical axis) and the level of difficulty of making cost reduction efforts (a horizontal axis), based on the accounting data of the buyer B (the Z company). A size of a bubble of each of the purchase targets plotted in the graph represents an amount of expenditure. Therefore, it is known that, for example, among the purchase targets plotted in the graph, multifunction machines are regarded as having the highest amount of expenditure, its degree of possibility of a cost reduction is extremely high, and its level of difficulty of making cost reduction efforts is extremely low. In this case, it is conceivable that multifunction machines are regarded as the purchase target with highest priority order of efforts. On the other hand, it is known that, for example, among the purchase targets plotted in the graph, new construction works are regarded as the third highest in amount of expenditure, but its degree of possibility of a cost reduction is extremely low, and its level of difficulty of making cost reduction efforts is extremely high. In this case, it is conceivable that new construction works are regarded as the purchase target with lowest priority order of efforts. An arrow Y illustrated at a center in the graph in FIG. 9, extending from the top right toward the bottom left, is an arrow extending from those with the higher priority order of efforts toward those with lower priority order. Therefore, for example, in the example illustrated in the graph in FIG. 9, the priority order of efforts is set in order from multifunction machines, printed materials, power, cleaning, and mobile and landline phones. Targets are thus extracted in this order. Note that new construction works, design and production, advertisement publishing fees, and postage, as illustrated in the graph in FIG. 9, are classified as purchase targets with lower degrees of possibility of a cost reduction and higher levels of difficulty of making cost reduction efforts, and are thus excluded from those subject to target extractions. Note that it is indicated that, among the purchase targets illustrated on the horizontal axis in the graph in FIG. 8, as described above, the purchase targets surrounded by no dotted line (i.e., new construction works, design and production, advertisement publishing fees, and postage) are the purchase targets excluded from those subject to target extractions.

That is, such a graph as illustrated in FIG. 9 includes, as to a plurality of items or services currently provided to the buyer, information regarding at least one determinant factor among a degree of possibility of reduction, a level of difficulty of efforts, and an amount of money to be paid. Therefore, the determination and extraction unit 105 in FIG. 6 is able to generate or acquire a graph as illustrated in FIG. 9 to determine and extract, based on the graph, purchase targets for which contract prices are to be predicted.

FIG. 10 is a view illustrating a specific example of “creating a management table of purchase targets” that takes place at Step 1 in the project design phase in the purchase optimization project in FIG. 1.

As described above, the management table of purchase targets is a table used to manage purchase targets that are each subject to cost reduction efforts. In the management table of purchase targets, specific information regarding item names, purchase amounts of money (yen/year), and suppliers who are current business partners is managed per department in the buyer B. In the example of the management table of purchase targets illustrated in FIG. 10, purchase targets that are each subject to cost reduction efforts in the department in charge of general affairs, the department in charge of facility management, and the department in charge of sales promotion in the buyer B are exemplified. Specifically, for example, multifunction machines, power, and mobile and landline phones are regarded as the purchase targets that are each subject to cost reduction efforts in the department in charge of general affairs. Furthermore, for example, cleaning, repair works, and security services are regarded as the purchase targets that are each subject to cost reduction efforts in the department in charge of facility management. Furthermore, for example, printed materials (advertising and other paper) and labels are regarded as the purchase targets that are each subject to cost reduction efforts in the department in charge of sales promotion. Among them, as to “multifunction machines” that are each subject to cost reduction efforts in the department in charge of general affairs, their annual purchase amount of money is “470,000,000 yen”, and a supplier who is an existing business partner is “OO Trading Corporation”. Furthermore, as to “power”, its annual purchase amount of money is “180,000,000 yen”, and a supplier who is an existing business partner is “OO Power Corporation”. Furthermore, as to “mobile and landline phones”, its annual purchase amount of money is “150,000,000 yen”, and a supplier who is an existing business partner is “OO Corporation”. Note that details of purchase targets that are each subject to cost reduction efforts in the department in charge of facility management and the department in charge of sales promotion in the buyer B are as illustrated in FIG. 10.

FIG. 11 is a view illustrating a specific example of “creating schedule plans” that takes place at Step 2 in the project design phase in the purchase optimization project in FIG. 1.

As described above, to create a schedule plan, a schedule plan per individual case that is subject to cost reduction efforts is created based on the priority order of efforts to be taken in each department in the buyer B. As illustrated in FIG. 11, examples that serve as points to create a schedule plan include a contract renewal month, a closing timing, a peak season, and a unit price renewal period. In the example of the schedule plans illustrated in FIG. 11, the schedule plans are respectively created for multifunction machines, power, and mobile and landline phones, for example, that are regarded as the purchase targets that are each subject to cost reduction efforts in the department in charge of general affairs in the buyer B. Specifically, for example, in the schedule plan for multifunction machines, cost reduction efforts are scheduled to take place from the beginning of April to the end of May. Furthermore, in the schedule plan for power, cost reduction efforts are scheduled to take place from the middle of April to the middle of June. Furthermore, in the schedule plan for mobile and landline phones, cost reduction efforts are scheduled to take place from the beginning of May to the end of June. Note that the schedule plans for the purchase targets that are each subject to cost reduction efforts in the department in charge of facility management and the department in charge of sales promotion in the buyer B are as illustrated in FIG. 11.

FIG. 12 is a view illustrating a specific example of “creating a list of suppliers” that takes place at Step 4 in the individual case execution phase in the purchase optimization project in FIG. 1.

As described above, to create a list of suppliers including information regarding one or more suppliers C who are deemed to be candidate business partners, the supplier DB 182 storing the supplier information is utilized. To improve an investigation, supplier information that is stored and managed in the supplier DB 182 contains not only supplier information on the suppliers C who are existing business partners but also supplier information on the other suppliers C who may be new business partners. The list of suppliers includes, as illustrated in FIG. 12, for example, information indicating, as to the suppliers C, their transaction statuses, company names, locations of headquarters, sales amounts, capitals, and numbers of employees. Specifically, for example, the list of suppliers illustrated in FIG. 12 exemplifies the supplier C with a transaction status of “Existing”, a company name of “OO Trading Corporation”, a location of headquarters of “OO building, OO X-XX-XX, OO ward, TOKYO”, a sales amount (million yen) of “430,000”, a capital (million yen) of “90,000”, and a number of employees (persons) of “2,500”, and the supplier C with a transaction status of “New”, a company name of “OO Commerce Corporation”, a location of headquarters of “OO tower, OO X-XX-XX, OO ward, TOKYO”, a sales amount (million yen) of “460,000”, a capital (million yen) of “15,000”, and a number of employees (persons) of “2,800”.

FIG. 13 is a view illustrating a specific example of “acquiring competitive quotes, and holding electronic bidding” that takes place at Step 5 in the individual case execution phase in the purchase optimization project in FIG. 1.

To acquire competitive quotes (to hold so-called one-time bidding), as described above, the service provider G requests a plurality of suppliers C (for example, the suppliers C1 to C4 in FIG. 13) for quotes to acquire competitive quotes. A quotes comparison table summarizing a result of comparison is then presented to the buyer B. As described above, the service provider G collectively communicates with each of the suppliers C. While presenting the quotes comparison table to the buyer B, the service provider G then makes proposals and inquiries to complement the content of the specification sheet.

Furthermore, to hold electronic bidding, as described above, the Website dedicated to electronic bidding, which the present service provides, or an existing reverse auction site soliciting bids, for example, is utilized to hold bidding in such a closed environment.

To summarize those described above, it is possible to expect effects described below with the present service. That is, the buyer B is able to collectively perform purchases necessary in a group (for example, consolidated subsidiary companies, factories, and acquired companies) centered around a parent company to take advantage of scale. Furthermore, it is possible to assist an integration process after merger and acquisition (M&A) termed as Post Merger Integration (PMI).

Although the embodiment of the present invention has been described, the present invention is not limited to the embodiment described above. The present invention is still deemed to include amendments and modifications, for example, that fall within the scope of the present invention, as long as it is possible to achieve the object of the present invention.

For example, in the embodiment described above, the purchase targets that are subject to cost reduction are mere examples. For example, it is possible to further include, in the purchase targets, for example, rental mats, office consumable items, building maintenance works, inspection of firefighting equipment, repair works, restoration works, shopping bags, personal computers, processed food products, logistics consumable items, and damage insurance.

Furthermore, for example, in the embodiment described above, the purchase requirements include the manufacturing lot and the size as the “purchase volume” in the buyer B. However, these are mere examples. It is possible to define the “purchase volume” per purchase target. Specifically, for example, when a purchase target is “power”, “power usage” is defined as a “purchase volume”.

Furthermore, for example, in the embodiment described above, the buyer requirements include the scale of company, the capital amount, the number of employees, and the sales amount as the “credit strength” of the buyer B. However, these are mere examples. For example, a result of an investigation conducted by a predetermined credit investigation company may be applied.

Furthermore, for example, FIG. 1 illustrates the four factor patterns and the six negotiation scheme patterns. However, these are mere examples. It is possible to adopt factor patterns and negotiation scheme patterns other than the factor patterns and the negotiation scheme patterns illustrated in FIG. 1.

Furthermore, the system configuration illustrated in FIG. 4, and the hardware configuration of the server 1 illustrated in FIG. 5 are mere examples used to achieve the object of the present invention. The present invention is not particularly limited to these configurations.

Furthermore, the functional block diagram illustrated in FIG. 6 is a mere example. The present invention is not particularly limited to the functional block diagram illustrated in FIG. 6. That is, it is enough that an information processing system has functions that make it possible to execute the series of processing described above. Functional blocks used to achieve the functions are not particularly limited to the functional blocks illustrated in the example in FIG. 6.

Furthermore, locations at which the functional blocks are present are not limited to the locations in FIG. 6. Desired locations may be selected. For example, in the example in FIG. 6, the contract price prediction processing described above takes place on the server 1 side. However, the present invention is not limited to this configuration. At least part of the contract price prediction processing may take place on the buyer terminal 2 side. That is, the functional blocks necessary for executing the contract price prediction processing are those disposed on the server 1 side. However, the configuration is a mere example. At least some of the functional blocks disposed on the server 1 may be disposed on the buyer terminal 2 side.

Furthermore, it is possible to use hardware or software to execute the series of processing described above. Furthermore, a single piece of hardware may configure one functional block. A single piece of software may configure one functional block. A combination of pieces of hardware and software may configure one functional block.

To execute, with software, the series of processing, a program configuring the software is installed into a computer from a network or a recording medium, for example. The computer may be such a computer incorporated in special hardware. Furthermore, the computer may be such a computer installed with various programs used to execute various functions, such as general-purpose smart phones and personal computers, in addition to servers.

A recording medium storing such programs as described above may not only be a non-illustrated removable medium distributed separately from a device main body to provide the programs to each advertiser, but also be a recording medium provided to each advertiser in a state where the recording medium is assembled beforehand in the device main body, for example.

Note that, in the present specification, steps describing programs recorded in a recording medium includes not only processes sequentially executed in a chronological order, but also processes that may not necessarily be executed in a chronological order, but may be executed in parallel or separately. Furthermore, in the present specification, the term system means a generic apparatus including a plurality of devices and a plurality of section, for example.

To summarize those described above, it is enough that the information processing device to which the present invention is applied takes a configuration as described below. The information processing device may still take one of various embodiments. That is, the information processing device (for example, the server 1 in FIG. 6) to which the present invention is applied is
an information processing device that predicts, as a contract price, a price (for example, an electricity cost) of a target that is an item or a service (for example, power regarded as a purchase target) to be provided by a first supplier (for example, the supplier C who is subject to prediction, as described above) to a buyer (for example, the buyer B described above). The information processing device includes:
reference price setting section (for example, the reference setting unit 101 in FIG. 6) that sets a reference price serving as a reference used to predict the contract price, based on an actual price of the target currently or previously provided by a second supplier (for example, the supplier C regarded as the existing business partner described above) to the buyer;
purchase requirements setting section (for example, the purchase requirements setting unit 102 in FIG. 6) that sets purchase requirements including at least a purchase volume (for example, power usage described above) of the target by the buyer, as requirements necessary for estimating a price of the target to be provided to the buyer;
buyer requirements setting section (for example, the buyer requirements setting unit 103 in FIG. 6) that sets, as buyer requirements, requirements regarding the buyer, the requirements including at least credit strength of the buyer (for example, the scale of the company described above); and
prediction section (for example, the prediction unit 104 in FIG. 6) that inputs the reference price, the purchase requirements, and the buyer requirements into a predetermined model that outputs a contract price to predict the contract price based on an output of the predetermined model. The predetermined model is generated or updated by applying machine learning that takes into account effects on a determination of the contract price, the effects being caused by at least one pattern among,
as one or more patterns (for example, the factor patterns in FIG. 1(A)) serving as factors for a cost reduction of the target to be provided by the first supplier to the buyer,
a pattern where a procurement cost price or a manufacturing cost price by the first supplier is lowering, a pattern where a competitive environment is established, and a pattern where a supply-demand relationship is relaxing and a market price is lowering.

Therefore, a contract price is predicted based on a price based on an actual price of the target provided to the buyer, requirements including at least a purchase volume of the target in the buyer, and requirements including at least the credit strength of the buyer. As a result, it is possible to predict a reasonable price regarded as a price to be offered by a supplier, making it possible to reduce an amount of money to be paid by a buyer, allowing the buyer to optimize a purchase. Furthermore, to predict a contract price, effects of one or more patterns serving as factors for a cost reduction are taken into account. Therefore, it is possible to predict a contract price allowing the buyer to achieve a purchase at a price close to a market price. As a result, the buyer is able to further reduce the cost.

Furthermore, it is possible that the machine learning further takes into account effects on the determination of the contract price, the effects being caused by at least one pattern among,
as one or more patterns (for example, the negotiation scheme patterns in FIG. 1(B)) serving as negotiation schemes for a cost reduction of the target to be provided by the first supplier to the buyer,
a pattern where advantage of scale is taken, a pattern where those for which competitive quotes are able to be acquired are extracted, a pattern where an ordering method is changed, a pattern where a discount rate is negotiated, a pattern where advantage of a new supplier side is taken, and a pattern where motivations for ongoing transactions with new suppliers are focused on.

Therefore, to predict a contract price, effects of one or more patterns serving as negotiation schemes for a cost reduction are taken into account. As a result, the buyer is able to perform a purchase at a lower price, that is, to further reduce the cost.

Furthermore, it is possible to further include target determination and extraction section (for example, the determination and extraction unit 105 in FIG. 6) that determines and extracts the target, from among a plurality of items or services currently provided to the buyer, based on data being outputted based on accounting data of the buyer, the data indicating a correlation between a degree of possibility of a cost reduction, a level of difficulty of making cost reduction efforts, and an amount of money to be paid of each of the items or services.

Therefore, a target that is an item or a service for which a contract price is to be predicted are determined and extracted based on data indicating a correlation between a degree of possibility of a cost reduction, a level of difficulty of making cost reduction efforts, and an amount of money to be paid of an item or a service. As a result, it is possible to focus on a purchase target for which effects to reduce a cost are expected, and to predict a contract price that a supplier may offer.

### EXPLANATION OF REFERENCE NUMERALS

1: Server, 2: Buyer terminal, 3, 3-1 to 3-n: Supplier terminal, 11: CPU, 12: ROM, 13: RAM, 14: Bus, 15: Input-and-output interface, 16: Input unit, 17: Output unit, 18: Storage unit, 19: Communication unit, 20: Drive, 30: Removable medium, 101: Reference setting unit, 102: Purchase requirements setting unit, 103: Buyer requirements setting unit, 104: Prediction unit, 105: Determination and extraction unit, 181: Buyer DB, 182: Supplier DB, G: Service provider, B: Buyer, C, C1 to Cn: Supplier, N: Network, Y: Arrow

1. An information processing device that predicts, as a contract price, a price of a target that is an item or a service to be provided by a first supplier to a buyer, the information processing device comprising:
reference price setting section that sets a reference price serving as a reference used to predict the contract price, based on an actual price of the target currently or previously provided by a second supplier to the buyer;
purchase requirements setting section that sets purchase requirements including at least a purchase volume of the target in the buyer, as requirements necessary for estimating a price of the target to be provided to the buyer;
buyer requirements setting section that sets, as buyer requirements, requirements regarding the buyer, the requirements including at least credit strength of the buyer; and
prediction section that inputs the reference price, the purchase requirements, and the buyer requirements into a predetermined model that outputs a contract price to predict the contract price based on an output of the predetermined model,
wherein the predetermined model is generated or updated by applying machine learning that takes into account effects on a determination of the contract price, the effects being caused by at least one pattern among,
as one or more patterns serving as factors for a cost reduction of the target to be provided by the first supplier to the buyer,
a pattern where a procurement cost price or a manufacturing cost price by the first supplier is lowering, a pattern where a competitive environment is established, and a pattern where a supply-demand relationship is relaxing and a market price is lowering.

2. The information processing device according to claim 1, wherein the machine learning further takes into account effects on the determination of the contract price, the effects being caused by at least one pattern among,
as one or more patterns serving as negotiation schemes for a cost reduction of the target to be provided by the first supplier to the buyer,
a pattern where advantage of scale is taken, a pattern where those for which competitive quotes are able to be acquired are extracted, a pattern where an ordering method is changed, a pattern where a discount rate is negotiated, a pattern where advantage of a new supplier side is taken, and a pattern where motivations for ongoing transactions with new suppliers are focused on.

3. The information processing device according to claim 1, further comprising target determination and extraction section that determines and extracts the target, from among a plurality of items or services currently provided to the buyer, based on data being outputted based on accounting data of the buyer, the data indicating a correlation between a degree of possibility of a cost reduction, a level of difficulty of making cost reduction efforts, and an amount of money to be paid of each of the items or services.
